(19) United States
(12) Patent Application Publication
(10) Pub. No.: US 2008/0178239 A1
(43) Pub. Date: Jul. 24, 2008

(54) System and method of providing selected video content

(75) Inventor: Mark Yampanis, Berkeley, CA (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/655,750

(22) Filed: Jan. 19, 2007

(51) Int. Cl. H04N 7/173

(52) U.S. Cl. 725/110

(57) ABSTRACT

A method of providing video content selections is presented that includes storing a personalized list associated with a customer, the personalized list identifying a plurality of video content selections. The method also includes receiving data from a set-top box device of the customer, the data indicating a request for personalized video content, where one of the video content selections identified by the personalized list is sent to the set-top box device via a private video distribution network. The method also includes automatically updating the personalized list according to a customer-defined updating rule associated with the personalized list.

### FIELD OF THE DISCLOSURE

The present disclosure relates generally to providing selected video content.

### BACKGROUND

Television viewing is a part of daily life for many people. Viewers have an ever-increasing choice of video content, including television programs, movies, live content, video-on-demand, online gaming, and pay-per-view programs. Viewers often determine what to watch based on personal preferences and information obtained from a variety of sources. However, many viewers have only limited time to obtain available information and make informed viewing choices. Hence, there is a need for an enhanced system and method of providing selected video content.

### BRIEF DESCRIPTION OF THE DRAWINGS

FIG. 1 is a block diagram of a particular illustrative embodiment of a system to provide selected video content;

FIG. 2 is a block diagram of a second particular illustrative embodiment of a system to provide selected video content;

FIG. 3 is a flow diagram of a particular illustrative embodiment of a method of providing selected video content;

FIG. 4 is a flow diagram of a second particular illustrative embodiment of a method of providing selected video content;

FIG. 5 is a diagram of a particular illustrative embodiment of an interface to provide selected video content;

FIG. 6 is a diagram of a second particular illustrative embodiment of an interface to provide selected video content;

FIG. 7 is a diagram of a third particular illustrative embodiment of an interface to provide selected video content;

FIG. 8 is a diagram of a fourth particular illustrative embodiment of an interface to provide selected video content; and

FIG. 9 is a diagram of an illustrative embodiment of a general computer system.

### DETAILED DESCRIPTION OF THE DRAWINGS

The present disclosure is generally directed to a system and method of providing selected video content. In a particular embodiment, a system to provide selected video content is disclosed that includes a server adapted to store a personalized list associated with a customer, the personalized list identifying a plurality of video content selections. The server is also adapted to receive data from a set-top box device of the customer, the data indicating a request for personalized video content. One of the video content selections identified by the personalized list is sent to the set-top box device via a private video distribution network. The server is also adapted to automatically update the personalized list according to a customer-defined updating rule associated with the personalized list.

In another embodiment, a set-top box device is disclosed that includes a processor and a memory device accessible to the processor. The memory device stores instructions executable by the processor to send a request for personalized video content to a customer list server of an Internet Protocol Television (IPTV) system. The memory device also stores instructions executable by the processor to receive a video content selection identified by a personalized list from a content source of the IPTV system via a private access network.

In another embodiment, the disclosure is directed to a method of providing selected video content that includes storing a personalized list associated with a customer, the personalized list identifying a plurality of video content selections. The method also includes receiving data from a set-top box device of the customer, where the data indicates a request for personalized video content. One of the video content selections identified by the personalized list is sent to the set-top box device via a private video distribution network. The method also includes automatically updating the personalized list according to a customer-defined updating rule associated with the personalized list.

In another embodiment, the disclosure is directed to a method of providing selected video content selections that includes storing a plurality of personalized lists of video content selections associated with each of a plurality of users. The method also includes storing a group list that identifies video content selections from at least one of the plurality of personalized lists. The method further includes receiving a request for group list video content from a set-top box device associated with the plurality of users. The method also includes instructing a content source to send a particular video content selection identified by the group list to the set-top box device via a private video distribution network. In addition, the method includes updating the group list to identify another video content selection identified by one of the plurality of personalized lists according to a group list updating rule associated with the group list.

In another embodiment, the disclosure is directed to a computer-readable medium tangibly embodying instructions executable by a processor to store a personalized list associated with a customer, the personalized list identifying a plurality of video content selections. The computer-readable medium also includes instructions executable by the processor to receive data from a set-top box device of the customer, where the data indicates a request for personalized video content and one of the video content selections identified by the personalized list is sent to the set-top box device via a private video distribution network. Further, the computer-readable medium includes instructions executable by the processor to automatically update the personalized list according to a customer-defined updating rule associated with the personalized list.

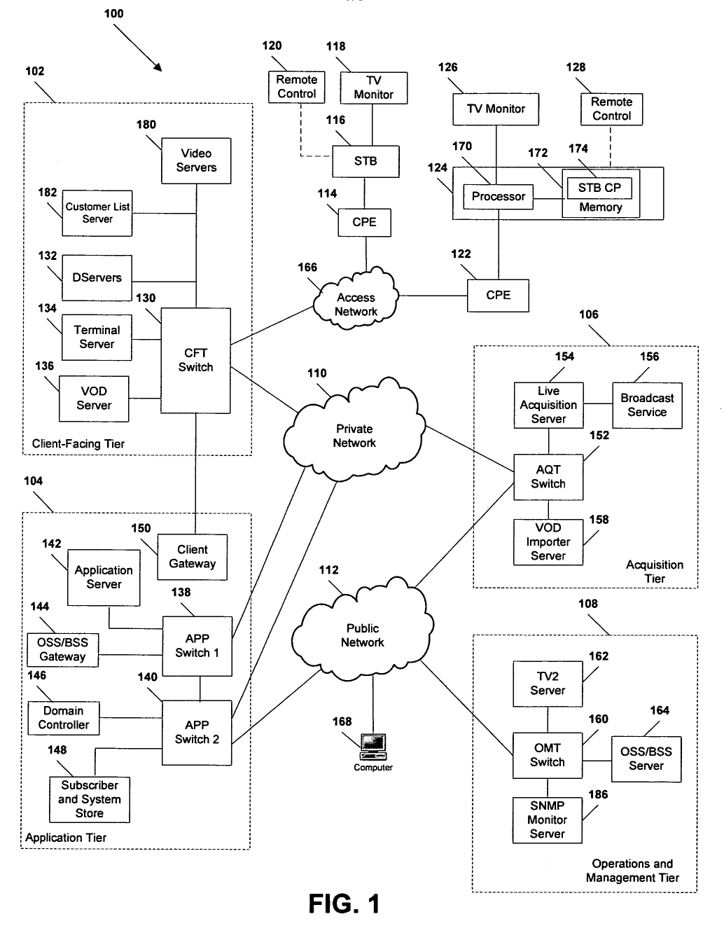

Referring to FIG. 1, an illustrative embodiment of an Internet Protocol Television (IPTV) system that may be used to provide selected video content is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 can communicate with user equipment via an access network 166, such as an Internet Protocol Television (IPTV) access network. In an illustrative embodiment, customer premises equipment (CPE) 114, 122 can be coupled to a local switch, router, or other device of the access network 166. The client-facing tier 102 can communicate with a first representative set-top box device 116 via the first CPE 114 and with a second representative set-top box device 124 via the second CPE 122. In a particular embodiment, the first representative set-top box device 116 and the first CPE 114 can be located at a first customer premise, and the second representative set-top box device 124 and the second CPE 122 can be located at a second customer premise. In another particular embodiment, the first representative set-top box device 116 and the second representative set-top box device 124 can be located at a single customer premise, both coupled to one of the CPE 114, 122. The CPE 114, 122 can include routers, local area network devices, modems, such as digital subscriber line (DSL) modems, any other suitable devices for facilitating communication between a set-top box device and the access network 166, or any combination thereof.

In an exemplary embodiment, the client-facing tier 102 can be coupled to the CPE 114, 122 via fiber optic cables. In another exemplary embodiment, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Cisco® Content Delivery Platform or Microsoft® TV IPTV Edition.

The first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, the set-top box devices 116, 124 can include a STB processor 170 and a STB memory device 172 that is accessible to the STB processor 170. In one embodiment, a computer program, such as the STB computer program 174, can be embedded within the STB memory device 172.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a point of connection to the IPTV system 100 via the client-facing tier 102. In a particular embodiment, the CFT switch 130 can be coupled to a video-on-demand (VOD) server 136 that stores or provides VOD content imported by the IPTV system 100. Further, the CFT switch 130 is coupled to one or more video servers 180 that receive video content and transmit the content to the set-top boxes 116, 124 via the access network 166. In a particular embodiment, the CFT switch 130 can be coupled to a customer list server 182 that stores and updates personalized lists of video content selections associated with various customers, e.g., with customer accounts that may include one or more users.

In an illustrative embodiment, the client-facing tier 102 can communicate with a large number of set-top boxes, such as the representative set-top boxes 116, 124 over a wide geographic area, such as a metropolitan area, a viewing area, a statewide area, a regional area, a nationwide area or any other suitable geographic area, market area, or subscriber or customer group that can be supported by networking the client-facing tier 102 to numerous set-top box devices. In a particular embodiment, the CFT switch 130, or any portion thereof, can include a multicast router or switch that communicates with multiple set-top box devices via a multicast-enabled network.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as interactive program guides, video gaming, display, messaging, processing of VOD material and other IPTV content, etc. In an illustrative embodiment, the application server 142 can provide location information to the set-top box devices 116, 124. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

The second APP switch 140 can be coupled to a domain controller 146 that provides Internet access, for example, to users at their computers 168 via the public network 112. For example, the domain controller 146 can provide remote Internet access to IPTV account information, e-mail, personalized Internet services, or other online services via the public network 112. In addition, the second APP switch 140 can be coupled to a subscriber and system store 148 that includes account information, such as account information that is associated with users who access the IPTV system 100 via the private network 110 or the public network 112. In an illustrative embodiment, the subscriber and system store 148 can store subscriber or customer data and create subscriber or customer profiles that are associated with IP addresses, stock-keeping unit (SKU) numbers, other identifiers, or any combination thereof, of corresponding set-top box devices 116, 124. In another illustrative embodiment, the subscriber and system store can store data associated with capabilities of set-top box devices associated with particular customers.

In a particular embodiment, the application tier 104 can include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164. After the client gateway 150 confirms subscriber and/or billing information, the client gateway 150 can allow the set-top box device 116 to access IPTV content and VOD content at the client-facing tier 102. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television content, movie content, advertisement content, other video content, or any combination thereof, from a broadcast service 156, such as a satellite acquisition system or satellite head-end office. In a particular embodiment, the live acquisition server 154 can transmit content to the AQT switch 152, and the AQT switch 152 can transmit the content to the CFT switch 130 via the private network 110.

In an illustrative embodiment, content can be transmitted to the D-servers 132, where it can be encoded, formatted, stored, replicated, or otherwise manipulated and prepared for communication from the video server(s) 180 to the set-top box devices 116, 124. The CFT switch 130 can receive content from the video server(s) 180 and communicate the content to the CPE 114, 122 via the access network 166. The set-top box devices 116, 124 can receive the content via the CPE 114, 122, and can transmit the content to the television monitors 118, 126. In an illustrative embodiment, video or audio portions of the content can be streamed to the set-top box devices 116, 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, or when the customer list server 182 receives a request for personalized video content, the VOD server 136 can retrieve VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 186 that monitors network devices within or coupled to the IPTV system 100. In a particular embodiment, the OMT switch 160 can communicate with the AQT switch 152 via the public network 112.

In an illustrative embodiment, the live acquisition server 154 can transmit content to the AQT switch 152, and the AQT switch 152, in turn, can transmit the content to the OMT switch 160 via the public network 112. In this embodiment, the OMT switch 160 can transmit the content to the TV2 server 162 for display to users accessing the user interface at the TV2 server 162. For example, a user can access the TV2 server 162 using a personal computer 168 coupled to the public network 112.

In a particular illustrative embodiment, the customer list server 182 can receive a plurality of video content selections from a set-top box device, such as the second representative set-top box device 124. Alternatively, the customer list server 182 can receive such selections from a customer computing device, such as the computer 168, or a web-enabled phone or other mobile device (not shown), that communicates with a web portal via the public network 112. The customer list server 182 can generate a personalized list that includes the plurality of video content selections and can associate the list with the set-top box device 124, a customer corresponding to the set-top box device 124 (e.g., a customer account or a user associated with a customer account), or any combination thereof.

In a particular embodiment, the customer list server 182 can provide available program selections, such as available video-on-demand selections, pre-recorded pay-per-view selections (e.g., pay-per-view movie content), live pay-per-view selections (e.g., pay-per-view sports or concert selections), or any combination thereof, to the set-top box device 124. A customer can populate the personalized list of video content selections by choosing items from the available program selections provided by the customer list server 182. In another embodiment, the customer can populate the personalized list by selecting one or more items from an electronic program guide (EPG) or by manually entering identifications of video content selections to be added to the personalized list. In yet another embodiment, the customer can populate the list with one or more placeholders for upcoming video releases that are announced but not yet available for selection.

In an alternative, non-limiting embodiment, the customer list server 182 can receive one or more user preferences to populate the personalized list, such as one or more actor, content type or subject matter preferences. The customer list server 182 can receive data related to available programming, for example, from the broadcast service 156, VOD importer server 158, or other device of the IPTV system 100. The customer list server 182 can compare the received data to customer preferences to generate a personalized list of video content selections.

In an illustrative embodiment, the customer list server 182 can receive a request from the set-top box device 124 for video content associated with the personalized list. In response to the request, the customer list server 182 can identify a personalized list associated with the set-top box device 124, or with a customer related to the set-top box device 124, and can identify a video content selection from the personalized list that is to be sent to the set-top box device 124. In a particular embodiment, the customer list server 182 can send the identified video content selection to the set-top box device 124 or can instruct a video server 180, VOD server 136, or other server of the IPTV system 100, to send the identified video content selection to the set-top box device 124.

In an illustrative embodiment, the request can indicate a general command for video content identified by the personalized list, and the customer list server 182 can cause the video selection identified at a first position of the personalized list to be sent to the set-top box device 124. In another embodiment, the customer list server 182 can send data corresponding to the personalized list to the set-top box device 124, and the customer can choose a particular video content selection from the personalized list. The customer list server 182 can receive data indicating the customer choice and can cause the particular video content selection to be sent to the set-top box device 124.

In a particular embodiment, the customer list server 182 can remove the identification of the video content selection sent to the set-top box device 124 from the personalized list. Further, the customer list server 182 can update the personalized list to replace the identification of the video content selection that was sent with an identification of another video content selection. For instance, the personalized list can identify a certain number of video content selections, such as five selections, ranging from a first video content selection to a last video content selection. A video selection identified first on the personalized list can be sent to the set-top box device 124. The customer list server 182 can remove the identification of the video selection sent to the set-top box device 124 from the personalized list, and the identifications of video content selections remaining on the personalized list can each be moved one position toward the first position of the personalized list. The last position in the personalized list can be populated with an identification of another video content selection, such that the personalized list remains filled.

In another example, the request received from the set-top box device 124 can identify a particular video content selection identified by the personalized list, such as a video content selection listed third by the personalized list. The customer list server 182 can instruct the video server 180, for example, to send the particular video content selection to the set-top box device 124, and the customer list server 182 can remove the identification of the video selection from the personalized list. The third position of the list can be repopulated with an identification of another video content selection, or identifications of remaining video content selections can be repositioned, such that the last position of the personalized list can be repopulated.

In a particular embodiment, one or more updating rules can be associated with a customer's personalized list of video content selections. An updating rule can include a rule used by the customer list server 182 to automatically update or otherwise repopulate the personalized list to identify additional video content selections when an identification of a video selection sent to the set-top box device 124 is removed. For example, an updating rule can indicate that the personalized list is to be updated based on recommendations of a certain movie critic. In an illustrative embodiment, the customer list server 182 can access the critic's recommendations via the public network 112 and can update the personalized list to identify video content selections recommended by the critic. In another embodiment, the updating rule can indicate that the personalized list is to be updated based on a customer preference, such as “latest pay-per-view comedy movie.” In still another embodiment, the updating rule can indicate that the personalized list is to be updated based on a recommendation or review by another customer.

In a particular embodiment, the customer can select an updating rule from a plurality of available rules when the personalized list is initially populated, as part of preferences used to generate the initial personalized list, or at any time thereafter. The updating rule can be received by the customer list server 182 from the set-top box device 124 or from the computing device 168 via an Internet portal. In an illustrative embodiment, the customer can select multiple rules. For example, the personalized list can be repopulated based on a first rule related to new pay-per-view comedy movies; based on a second rule related to latest pay-per-view boxing events; and a third rule related to a critic recommendation. A position of the personalized list can be updated to identify a latest boxing event, if no latest pay-per-view comedy movies are available, and with a critic recommendation if neither a latest pay-per-view boxing event, nor a latest comedy pay-per-view movie are available.

In a particular embodiment, the customer list server 182 can associate multiple personalized lists with a single customer or set-top box device. For example, if a plurality of users reside in a single home, college dormitory, assisted living facility, or regularly go to a fire station, sports bar, or other business, a personalized list of video content selections can be generated and stored for each user at the customer list server 182. Each of the personalized lists can be populated manually through user selections of video content, automatically according to user video content preferences, or any combination thereof.

Further, the customer list server 182 can store a group list associated with the set-top box device 124 or with a customer related to the set-top box device 124. The group list can include video content selections from one or more of the personalized lists associated with the plurality of users. For example, the group list can include video content selections identified first on each of the personalized lists. The group list can be automatically updated according to a group list updating rule that dictates how the group list is repopulated to identify additional video content selections after a video selection previously identified by the group list is removed from the group list (i.e., because the video content selection has been sent to the set-top box device 124 or another set-top box device at the customer premise in response to a request).

For example, the group list updating rule can stipulate that the group list is to be updated to identify one or more video selections common to all of the personalized lists or to a majority or other group of the personalized lists. In another example, the group list updating rule can stipulate that the group list is to be updated to identify a video content selection from each of the plurality of personalized lists on an alternating basis. In an illustrative, non-limiting embodiment, the customer associated with the set-top box device 124, another user, or any combination thereof, can alter the group list to eliminate an identification of a video content selection, for example, by inputting a veto command and authentication token at the set-top box device 124 or computing device 168.

The customer list server 182 is used for convenience in explaining the disclosed systems and methods. It will be readily apparent to those skilled in the art that other implementations are possible, which do not depart from the scope of this disclosure. For example, the functions provided by the customer list server 182 can be performed by one or more applications stored at the application server 142 or another server of the IPTV system 100 that stores multiple applications providing various features of the IPTV system 100.

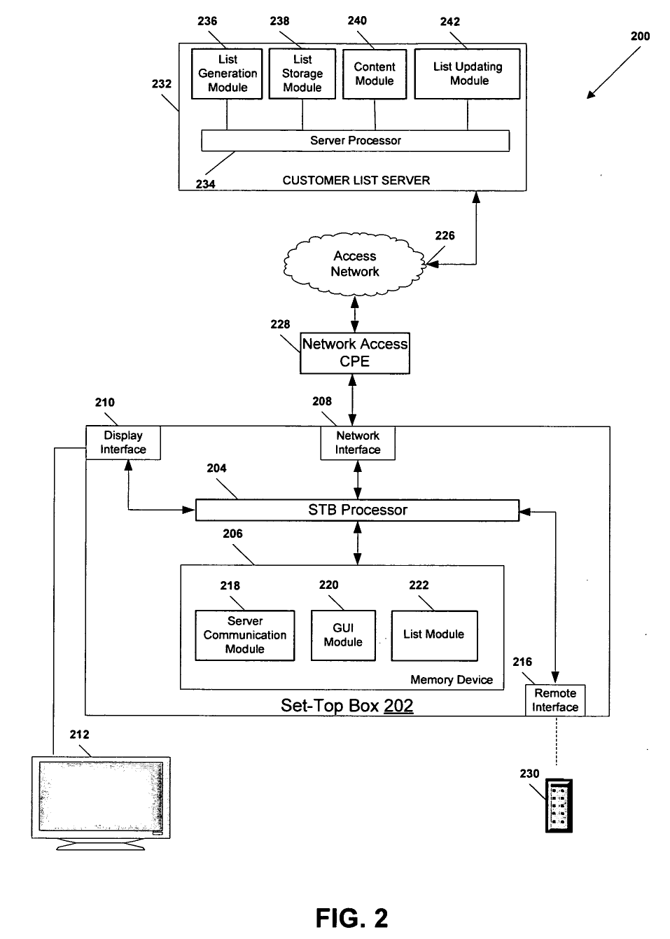

Referring to FIG. 2, a second particular embodiment of a system to provide selected video content is depicted and generally designated 200. The system 200 includes a set-top box device (STB) 202 that communicates with a customer list server 232 via a private access network 226. In a particular embodiment, the private access network 226 can be a private access network of an Internet Protocol Television (IPTV) system. In an illustrative, alternative embodiment, the customer list server 232 can be implemented as an application running at a server that stores multiple applications providing various features of a triple-play, quad-play, or other video distribution system.

As indicated in FIG. 2, the set-top box device 202 includes a STB processor 204 and a memory device 206 accessible to the STB processor 204. The STB processor 204 can communicate video content to a display device 212 via a display interface 210. In addition, the STB processor 204 can receive commands from a remote control device 230 via a remote interface 216. In an illustrative, non-limiting embodiment, the STB processor 204 can communicate with the access network 226 via a network interface 208. In a particular embodiment, customer premises equipment (CPE) 228 can facilitate communication between the network interface 208 and the access network 226. The CPE 228 can include a router, switch, a local area network device, a modem, such as a digital subscriber line (DSL) modem, any other suitable device for facilitating communication between the network interface 208 of the set-top box device 202 and the access network 226, or any combination thereof.

In a particular embodiment, the memory device 206 can include a server communication module 218 that is executable to send data to the customer list server 232 indicating video content selections to be added to a personalized list of video content selections associated with the set-top box device. Further, the server communication module 218 can be executable to send data to the customer list server 232 indicating customer preferences, updating rules, or any combination thereof. In addition, the server communication module 218 can be executable to send requests for video content identified by the personalized list or a group list to the customer list server 232.

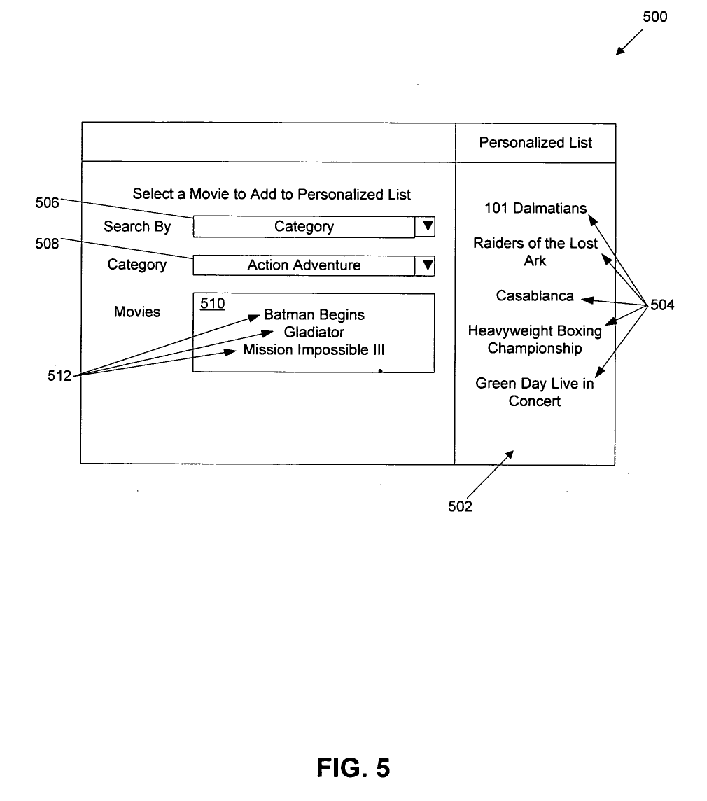

In an illustrative embodiment, the memory device 206 can include a graphical user interface (GUI) module 220 that is executable by the STB processor 204 to send one or more graphical user interfaces (GUIs) to the display device 212. A customer or other user can interact with the GUI(s) to input data related to a personalized list or group list of video content selections, to select a particular video content selection from a personalized list or group list, or any combination thereof. Examples of such GUIs are illustrated in FIGS. 5-8.

In an illustrative, non-limiting embodiment, the memory device 206 can include a list module 222 that is executable by the STB processor 204 to store one or more personalized lists or group lists locally. In an illustrative embodiment, the set-top box device 202 can receive updates to the personalized list from the customer list server 232 and can identify video content selections from the personalized list to request from the customer list server 232 in response to user commands received at the set-top box device 202.

For ease of explanation, the modules 218-222 have been described as instructions executable by the STB processor 204. Nonetheless, the modules 218-222 can include hardware logic, instructions, or any combination thereof.

As illustrated in FIG. 2, the customer list server 232 can include a server processor 234 and a plurality of modules 236-242 accessible to the server processor 234. In a particular embodiment, the customer list server 232 can include a list generation module 236 executable by the server processor 234 to generate personalized lists and group lists of video content selections based on data received from set-top box devices, such as the set-top box device 202. In a particular embodiment, list generation module 236 can be executable by the server processor 234 to provide data to the set-top box device 202 indicating available video content.

The list generation module 236 can be executable by the server processor 234 to receive selections of available video content from the set-top box device 202 to generate a personalized list of video content selections. In another embodiment, the list generation module 236 can be executable by the server processor 234 to generate a personalized list of video content selections by selecting from the available video content based on customer preferences received from the set-top box device 202. In a particular embodiment, personalized lists and group lists can be stored at a list storage module 238.

In a particular embodiment, the customer list server 232 can include a content module 240 that is executable by the server processor 234 to receive a request from the set-top box device 202 for video content identified by a personalized or group list. The content module 240 can be executable by the server processor 234 to identify a personalized list or group list associated with the set-top box device 202, or a customer related thereto, and to retrieve the personalized list or group list from the list storage module 238. Further, the content module 240 can be executable by the server processor 234 to select a video content selection identified by the personalized list or group list, based on the request received from the set-top box device 202, and to instruct another device to send the selected video content to the set-top box device 202. In a particular embodiment, the content module 240 can be executable by the server processor 234 to send the personalized list or group list to the set-top box device 202 and to receive a selection of particular video content identified by the list.

In a particular embodiment, the customer list server 232 can include a list updating module 242 that is executable by the server processor 234 to remove identifications of video content selections sent to the set-top box device 202 from a personalize list, group list, or any combination thereof. In an illustrative embodiment, the list updating module 242 that is executable by the server processor 234 to reposition remaining identifications of video content selections within a list after one or more has been removed. Further, the list updating module 242 can be executable by the server processor 234 to access data corresponding to available video content and data corresponding to one or more updating rules associated with a personalized list, group list, or any combination thereof. The list updating module 242 can be executable by the server processor 234 to automatically populate or update a list with video content selections based on the updating rule(s) associated with the list. In addition, the list updating module 242 can be executable by the server processor 234 to receive manually selected additions or other changes to a personalized list or group list from the set-top box device 202 and to update the list according to the changes.

In an illustrative, non-limiting embodiment, the list updating module 242 can be executable by the server processor 234 to remove additions or other changes upon receipt of a veto command or similar command, an authentication token, or any combination thereof, from a particular user associated with the list. For ease of explanation, the modules 236-242 have been described as instructions executable by the server processor 234. Nonetheless, the modules 236-242 can include hardware logic, instructions, or any combination thereof.

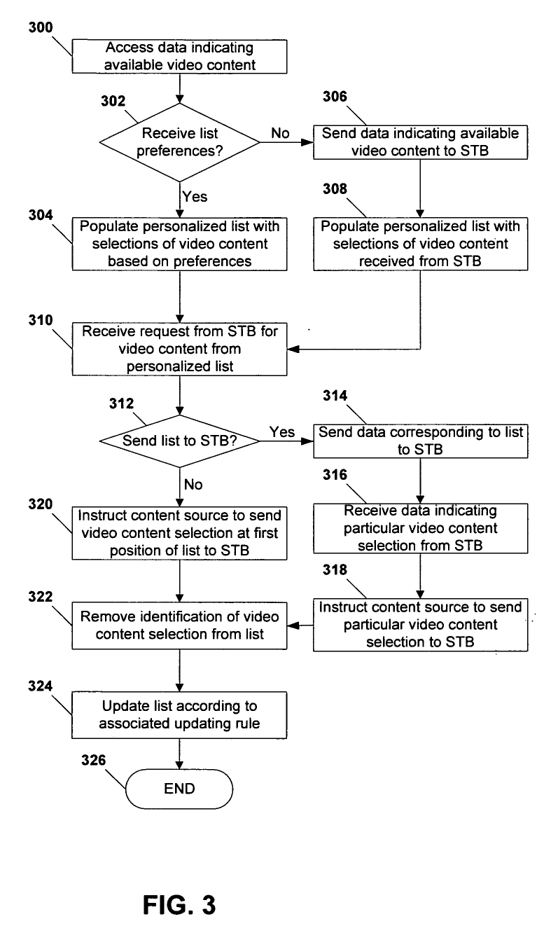

Referring to FIG. 3, a particular illustrative embodiment of a method of providing selected video content is illustrated. At block 300, in a particular embodiment, a server accesses data indicating available content from one or more content sources or other devices in order to populate a personalized list of video content selections associated with a customer. Moving to decision node 302, the server determines whether it has received customer preferences to generate a personalized list of video content selections from the available video content. If the server has received such preferences, the method proceeds to block 304, and the server populates a personalized list associated with the set-top box device, the customer, or any combination thereof, to identify video content selections based on the customer preferences, such as one or more genres, actors, types of content, release dates of content, latest releases, other preferences, or any combination thereof.

On the other hand, if the server has not receive customer preferences, the method moves to block 306, and the server sends data indicating available video content to the set-top box device associated with the customer. Continuing to block 308, the server populates the personalized list of video content selections with identifications of video content received from the set-top box device.

Proceeding to block 310, a request for video content identified by the personalized list is received from the set-top box device. At decision node 312, the server determines whether it is to send the personalized list to the set-top box device. If the server determines that it is to send the personalized list to the set-top box device, for instance, when the request indicates that the customer wants to select a particular video content selection from the list, the method advances to block 314, and the server sends data corresponding to the list to the set-top box device. At block 316, the server can receive a selection of particular video content from the set-top box device. Continuing to block 318, the server can instruct a content source to send the selected video content to the set-top box device.

Returning to bock 312, in an illustrative embodiment, if the server determines that it is not to send the personalized list to the set-top box device, for example, when the request indicates a general request for video content identified by the personalized list, the method proceeds to block 320, and the server can instruct a content source to send video content identified at a first position or other position of the personalized list to the set-top box device. Moving to block 322, the server can remove an identification of the video content sent to the set-top box device from the personalized list. Proceeding to block 324, the server updates the personalized list according to one or more updating rules associated with the personalized list. In a particular embodiment, the customer can select an updating rule from a plurality of available rules when the personalized list is initially populated, as part of preferences used to generate the initial personalized list, or at any time thereafter. The method terminates at 326.

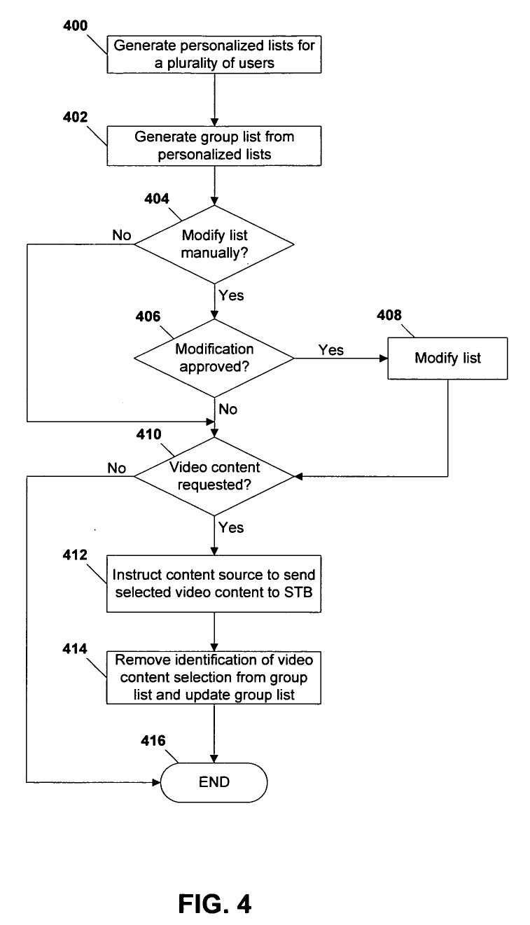

Referring to FIG. 4, a second particular illustrative embodiment of a method of providing selected video content is illustrated. At block 400, a server generates a personalized list of video content selections for each of a plurality of users associated with a set-top box device. In a particular embodiment, at least a portion of the personalized list can be automatically generated based on a user selection of personalized list rules that are maintained at a server of an Internet Protocol Television (IPTV) system. In a particular embodiment, at least a portion of the personalized list can be generated by user selections from a list of available video content selections.

Moving to block 402, the server generates a group list based on the video content selections of the personalized lists. For example, the group list can identify video content selections that are common to all of the personalized lists, at least one video content selection from each of the personalized lists, other combinations of video content from the personalized lists, or any combination thereof.

Continuing to decision node 404, in an illustrative embodiment, the server determines whether it has received a command from a user to manually modify the group list. In a particular embodiment, a user can manually modify the group list by adding video content selections, by removing video content selections, by changing a position of a video content selection, by making other changes, or any combination thereof. In an illustrative embodiment, a calendar function or similar function can be used to propose a time and date to view certain content, e.g., while users who dislike the content will be away. If the user has not elected to manually modify the group list, the method advances to decision node 410. Whereas, if a user has elected to manually modify the group list, the method proceeds to decision node 406, and the server determines whether the manual modification is approved. In a particular embodiment, modifications to a group list can be approved by a group list administrator, by rules governing a type of content allowed in the group list, by a majority of group participants, by a security policy for the group list that defines a level of access to the group list, by other approval mechanisms, or any combination thereof. If the modification is not approved, the list is not modified and the method proceeds to decision node 410. Whereas, if the modification is approved, the method continues at block 408, and the list is modified.

Moving to decision node 410, the server determines whether a video content selection is requested from the group list. If a video content selection is not requested, the method can terminate at 416. Conversely, if a video content selection is requested, the method advances to block 412, and the server instructs a content source to send selected video content from the group list to a set-top box device associated with at least one of the plurality of users. In a particular embodiment, the video content selection is provided by a video source of an IPTV system via a private video distribution network, such as via a private access network of the IPTV system.

Advancing to block 414, the server removes an identification of the video content sent to the set-top box from the group list and updates the group list according to an updating rule associated with the group list, such as populating the group list with video content selections that are common to all of the personalized lists of group participants, populating the group list with video content selections that are common to multiple personalized lists, populating the group list by alternately selecting video content selections from each of the personalized lists, populating a position of the group list with a first video content selection common to a majority of the personalized lists and populating a lower-priority position of the group list with a second selection common to a minority of the personalized lists, another updating rule, or any combination thereof. The method terminates at 416.

In a particular embodiment, the methods can be performed as described herein. Those skilled in the art will recognize that certain aspects the methods may be performed in various sequences, or simultaneously.

Referring to FIG. 5, a particular illustrative embodiment of a graphical user interface to provide selected video content is depicted and is generally designated 500. The interface 500 includes a personalized list 502 that identifies a plurality of video content selections 504. The interface 500 also includes a first search control 506 and a second search control 508. A second viewing area 510 displays a navigable and selectable menu of available video content selections 512.

In a particular embodiment, the first search control 506 and the second search control 508 can be used to manually update the video content selections 504 of the personalized list 502. The first search control 506 can provide first search criteria for available video content. In an illustrative embodiment, the first search control 506 can include criteria such as category, actors, directors, release dates, critics' favorites, friends' and family's favorites, other search criteria, or any combination thereof. In an illustrative embodiment, the second search control 508 can provide secondary search criteria corresponding to a selected first search criterion. As an illustrative, non-limiting example, if the first search criterion is “category,” the secondary search criteria can include categories such as action adventure, comedy, classics, drama, foreign, mystery, new releases, special interest, sports, and “view all categories.”

In a particular embodiment, the second viewing area 510 can display a navigable and selectable menu of available video content selections 512 of a list of all available video content selections that correspond to the first and second search criteria. A selection of one or more video content selections 512 can cause the selected video content selections 512 to be added the personalized list 502.

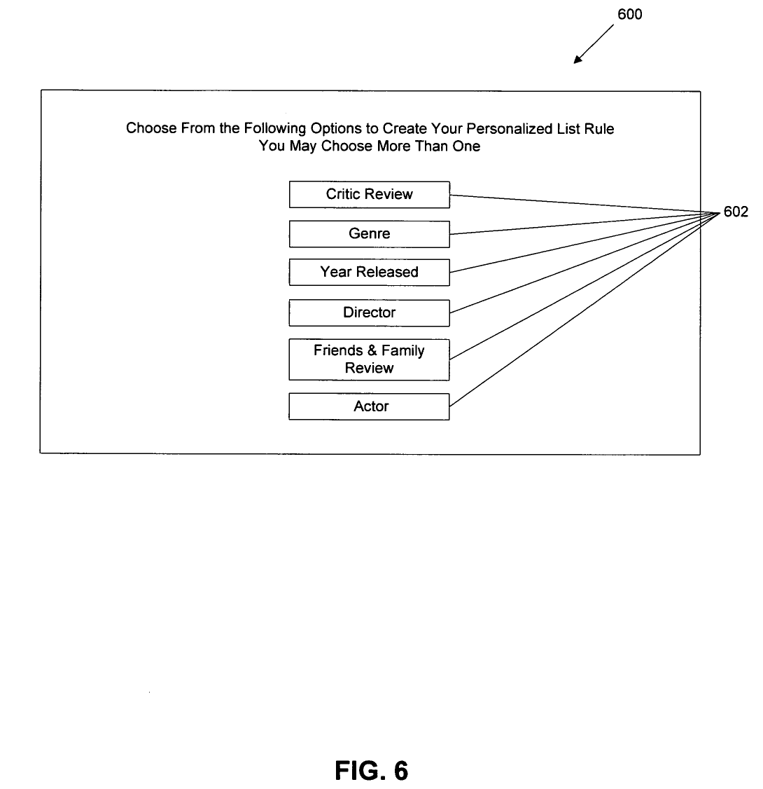

Referring to FIG. 6, a second particular illustrative embodiment of a graphical user interface to provide selected video content is depicted and is generally designated 600. The interface 600 includes multiple selectable indicators 602 of updating rules. In a particular embodiment, multiple updating rules can be selected. In a non-limiting, illustrative embodiment, the updating rules can include rules based on critic review, genre, year released, director, friends & family review, actor, other updating rules, or any combination thereof.

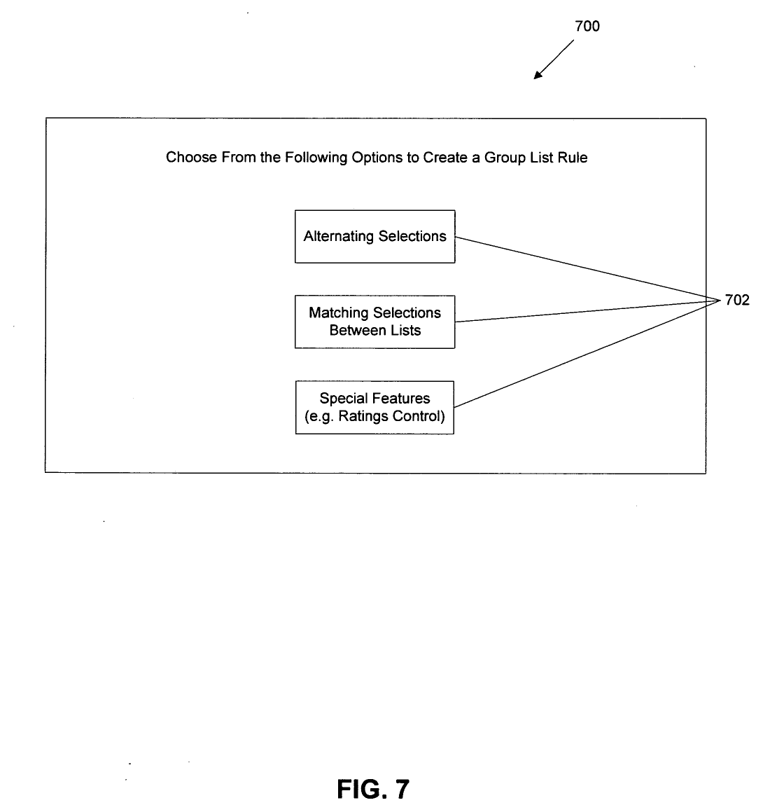

Referring to FIG. 7, a third particular illustrative embodiment of a graphical user interface to provide selected video content is depicted and is generally designated 700. The interface 700 can include selectable indicators 702 of updating rules to update a group list of video content selections. In a particular embodiment, multiple group list rules can be selected. The group list rules can determine an automatic population of the group list based on video content selections of group participants' personalized lists. In a non-limiting, illustrative embodiment, the group list rules can include rules to update the list based on alternating selections from the personalized lists, based on matching selections between the individual personalized lists, based on special features such as ratings controls, or any combination thereof.

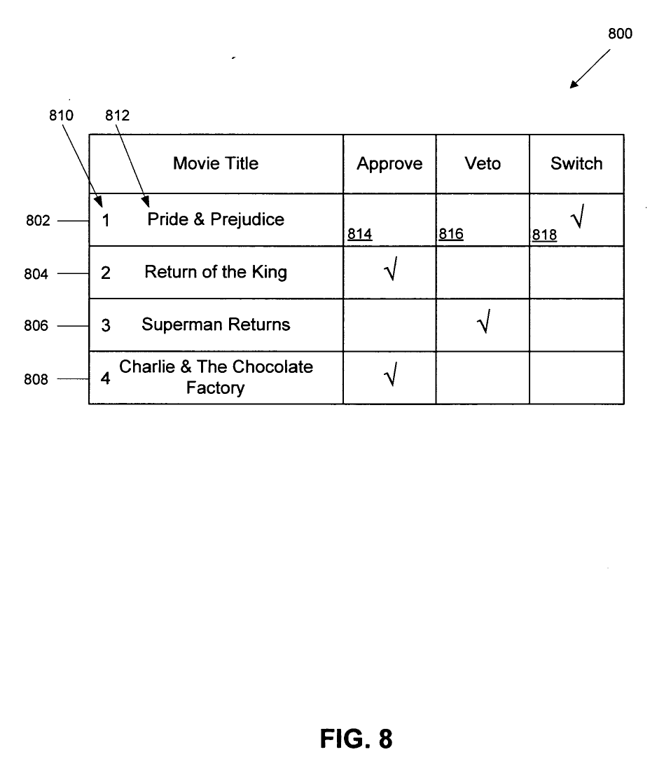

Referring to FIG. 8, a fourth particular illustrative embodiment of a graphical user interface to provide selected video content is depicted and is generally designated 800. The interface 800 can include multiple rows 802, 804, 806, and 808 that each correspond to a different video content selection identified by a group list. The first row 802 includes a list position indicator 810, a video content title 812, a selectable approval control 814, a selectable veto control 816, and a selectable move control 818.

In a particular embodiment, the user interface 800 can enable manual modification of an automatically generated list of video content selections. In an illustrative, non-limiting embodiment, a selection of the approval control 814 can leave the first video content selection of the list unchanged. A selection of the veto control 816 can remove the first video content selection from the list. A selection of the switch control 818 can reposition the first video content selection within the group list. In a particular embodiment, each row can have a corresponding approval, veto, and switch control that function substantially the same as the approval control 814, the veto control 816, and the move control 818.

In conjunction with the configuration of structure described herein, the systems and methods disclosed provide selected video content. In a particular illustrative embodiment, a server can receive a plurality of video content selections from a set-top box device. The server can generate a personalized list that includes the plurality of video content selections and can associate the list with the set-top box device.

In an illustrative embodiment, the server can receive a request from the set-top box device for video content associated with the personalized list. In response to the request, the server can identify a personalized list associated with the set-top box device, and can identify a video content selection from the personalized list that is to be sent to the set-top box device. In a particular embodiment, the server can send the identified video content selection to the set-top box device or can instruct a content source to send the identified video content selection to the set-top box device.

In a particular embodiment, the server can update the personalized list based on one or more updating rule to replace the identification of the video content selection that was sent with an identification of another video content selection. In a particular embodiment, the customer can select an updating rule from a plurality of available rules when the personalized list is initially populated, as part of preferences used to generate the initial personalized list, or at any time thereafter.

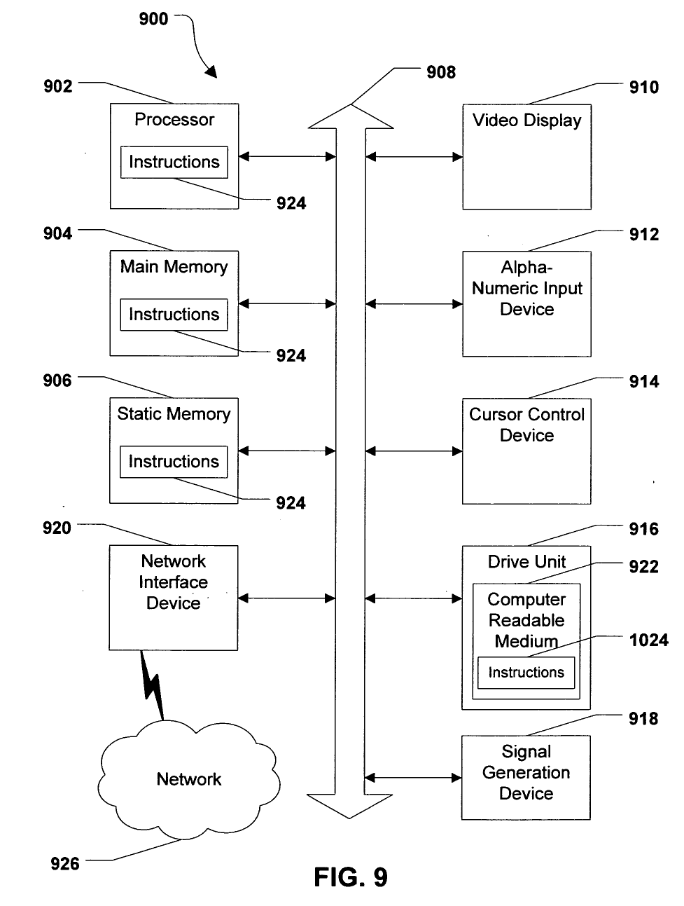

Referring to FIG. 9, an illustrative embodiment of a general computer system is shown and is designated 900. The computer system 900 can include a set of instructions that can be executed to cause the computer system 900 to perform any one or more of the methods or computer based functions disclosed herein. The computer system 900, or any portion thereof, may operate as a standalone device or may be connected, e.g., using a network, to other computer systems or peripheral devices, including a server or set-top box device, as shown in FIGS. 1-2.

In a networked deployment, the computer system may operate in the capacity of an IPTV server, such as a customer list server or a set-top box device. The computer system 900 can also be implemented as or incorporated into various devices, such as a personal computer (PC), a tablet PC, a set-top box (STB), a personal digital assistant (PDA), a mobile device, a palmtop computer, iPhone, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics-processing unit (GPU), or both. Moreover, the computer system 900 can include a main memory 904 and a static memory 906 that can communicate with each other via a bus 908. As shown, the computer system 900 may further include a video display unit 910, such as a liquid crystal display (LCD), an organic light emitting diode (OLED), a flat panel display, a solid state display, or a cathode ray tube (CRT). Additionally, the computer system 900 may include an input device 912, such as a keyboard, and a cursor control device 914, such as a mouse. The computer system 900 can also include a disk drive unit 916, a signal generation device 918, such as a speaker or remote control, and a network interface device 920.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 926 can communicate voice, video or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing selected video content, the method comprising:
storing a personalized list associated with a customer, the personalized list identifying a plurality of video content selections;
receiving data from a set-top box device of the customer, the data indicating a request for personalized video content, wherein one of the video content selections identified by the personalized list is sent to the set-top box device via a private video distribution network; and
automatically updating the personalized list according to a customer-defined updating rule associated with the personalized list.

2. The method of claim 1, further comprising:
sending data to the set-top box device indicating available video content that includes the plurality of video content selections; and
receiving data from the set-top box device indicating customer selections related to the plurality of video content selections, wherein the personalized list is initially populated to identify the plurality of video content selections.

3. The method of claim 1, further comprising:
receiving at least one customer list preference from the set-top box device;
accessing data indicating available video content that includes the plurality of video content selections; and
automatically populating the personalized list to identify the plurality of video content selections, wherein the plurality of video content selections match the at least one customer list preference.

4. The method of claim 1, further comprising receiving data from the set-top box device indicating a selection of the updating rule from a plurality of updating rules.

5. The method of claim 1, wherein the updating rule includes adding a video content selection to the personalized list based on a customer preference, an entertainment critic recommendation, a review by another customer, or any combination thereof.

6. The method of claim 1, wherein the video content selection is sent to the set-top box device via a private access network of an Internet Protocol Television (IPTV) system.

7. The method claim 1, further comprising receiving data corresponding to the updating rule, identifications of the plurality of video content selections, or any combination thereof, at a customer list server of the IPTV system via an Internet portal.

8. The method of claim 1, further comprising automatically removing an identification of the video content selection that is sent to the set-top box device from the personalized list.

9. The method of claim 8, wherein the personalized list comprises a plurality of positions arranged sequentially from a first position to a last position.

10. The method of claim 9, wherein the video content selection that is sent to the set-top box device is associated with the first position of the personalized list.

11. The method of claim 10, further comprising:
removing the video content selection that is sent to the set-top box device from the personalized list; and
updating a position of each video content selection remaining in the personalized list.

12. The method of claim 11, further comprising adding a new video content selection at the last position of the personalized list.

13. The method of claim 1, further comprising:
sending data corresponding to the personalized list to the set-top box device in response to the request to receive personalized video content; and
receiving a second request indicating the video content selection that is sent to the set-top box device.

14. The method of claim 1, wherein the personalized list identifies video-on-demand content, live pay-per-view video content, prerecorded pay-per-view video content, or any combination thereof.

15. The method of claim 1, further comprising instructing a content source to send the video content selection that is sent to the set-top box device.

16. A method of providing selected video content, the method comprising:
storing a plurality of personalized lists of video content selections associated with each of a plurality of users;
storing a group list that identifies video content selections from at least one of the plurality of personalized lists;
receiving a request for group list video content from a set-top box device associated with the plurality of users;
instructing a content source to send a particular video content selection identified by the group list to the set-top box device via a private video distribution network; and
updating the group list to identify another video content selection identified by one of the plurality of personalized lists according to a group list updating rule associated with the group list.

17. The method of claim 16, wherein at least a portion of the personalized lists are generated by user selections from a list of available video content selections.

18. The method of claim 16, wherein at least a portion of the personalized lists are automatically generated based on user selections of personalized list rules.

19. The method of claim 16, wherein the personalized list rules are stored at a customer list server of an Internet Protocol Television (IPTV) system.

20. The method of claim 16, wherein the group list rule includes updating the group list rule to identify a video content selection that is common to all of the personalized lists, a video content selection that is common to a plurality of the personalized lists, a video content selection alternately selected from each of the personalized lists, or any combination thereof.

21. A set-top box device, comprising:
a processor and a memory device accessible to the processor;
wherein the memory device stores instructions executable by the processor to:
send a request for personalized video content to a customer list server of an Internet Protocol Television (IPTV) system; and
receive a video content selection identified by a personalized list from a content source of the IPTV system via a private access network.

22. The set-top box device of claim 21, wherein the memory device stores instructions executable by the processor to send data to the customer list server indicating an updating rule selected by a customer associated with the personalized list.

23. The set-top box device of claim 21, wherein the memory device stores instructions executable by the processor to:
receive data corresponding to the personalized list from the customer list server;
receive a selection of a particular video content selection identified by the personalized list; and
send a request for the particular video content selection to the customer list server.

24. The set-top box device of claim 23, wherein the memory device stores instructions executable by the processor to send a selectable menu that includes a plurality of video content selections identified by the personalized list to a display device coupled to the set-top box device.

25. A system to provide video content selections, the system comprising:
a server adapted to:
store a personalized list associated with a customer, the personalized list identifying a plurality of video content selections;
receive data from a set-top box device of the customer, the data indicating a request for personalized video content, wherein one of the video content selections identified by the personalized list is sent to the set-top box device via a private video distribution network; and
automatically update the personalized list according to a customer-defined updating rule associated with the personalized list.

26. The system of claim 25, wherein the server is adapted to
update a second personalized list based on a second updating rule associated with a second customer; and
generate a group list of video content selections, the group list including at least a first video content selection of the first personalized list and a second video content selection of the second personalized list, wherein the group list is updated based on a group list updating rule.

27. A computer-readable medium tangibly embodying a set of instructions that are executable by a processor to:
store a personalized list associated with a customer, the personalized list identifying a plurality of video content selections;
receive data from a set-top box device of the customer, the data indicating a request for personalized video content, wherein one of the video content selections identified by the personalized list is sent to the set-top box device via a private video distribution network; and
automatically update the personalized list according to a customer-defined updating rule associated with the personalized list.

28. The computer-readable medium of claim 27, further comprising instructions executable by the processor to:
remove an identification of the video content selection sent to the set-top box device from the personalized list; and
add a second identification of an additional video content selection to the personalized list based on the updating rule.

29. The computer-readable medium of claim 27, further comprising instructions executable by the processor to modify the personalized list without sending a video content selection to the set-top box device when an instruction to manually modify the personalized list and an authentication token are received.

30. The computer-readable medium of claim 27, further comprising instructions executable by the processor to instruct a content source to send the video content selection to the set-top box device.
